(19) United States
(12) Patent Application Publication
(10) Pub. No.: US 2015/0306760 A1
(43) Pub. Date: Oct. 29, 2015

(54) TOOL BIT HANGER WITH VARIABLE LENGTH

(71) Applicant: Ji-Fen Meng, Taichung City (TW)

(72) Inventor: Ji-Fen Meng, Taichung City (TW)

(21) Appl. No.: 14/264,064

(22) Filed: Apr. 29, 2014

(51) Int. Cl. B25H 3/00

(52) U.S. Cl. CPC B25H 3/003

(57) ABSTRACT

A tool bit hanger includes a hanging member and at least two holding members detachably connected to one another in series. The hanging member is provided with a lateral hole by means of which the tool-bit hanger is able to be hung from a user's belt. Each of the holding members is formed in one piece of resilient synthetic resinous material, and includes a male end portion at a top thereof and a female end portion at a bottom thereof and a pair of lateral receptacles for reception of tool bits. In particular, the male end portion of one of the holding members is detachably engaged in the female end portion of the other holding member to lock the two holding members together.

### BACKGROUND OF THE INVENTION

1. Field of the Invention

The present invention relates to a hanger for holding multiple elongated objects such as drill bits, screwdriver bits and the like, and more particularly to a tool bit hanger with variable length.

2. Description of the Related Art

Typically tool bits, such as screwdriver bits, are sold in sets of 8 to 12 bits of sequential sizes, carried in a plastic carrying case which also functions to store the bits at the owner's workbench. A problem with such an approach to the marketing of bits is that it restricts the purchaser's flexibility in the selection and storing of various bit sizes. A purchaser will be forced to acquire separately a size of bit not included in the pre-packaged selection and will be unable to store the bit in the plastic package which contains the initial set.

As shown in FIG. 13, a tool bit hanger 900 is provided for carrying various of tool bits 81. The hanger 900 has a main body 9 integrally formed with multiple mounting recesses 91 for mounting the tool bits 81. However, since all of the tool bits 81 are mounted together in the respective mounting recesses 91, a user will have to carry all the tool bits 81 along all the time while working though only some of the tool bits 81 are required, thereby causing inconvenience to the user.

### SUMMARY OF THE INVENTION

Accordingly, it is an object of the present invention to provide a tool bit hanger to increase the user's flexibility in the selection and carrying of various bit sizes. The tool bit hanger includes a hanging member, a first holding member and a second holding member connected in series to one another.

Specifically, the hanging member is formed in one piece of resilient synthetic resinous material and is provided at its top with a lateral hole by means of which the tool-bit hanger is able to be hung. Moreover, the hanging member has at its bottom a female end portion. Each of the first and second holding members is formed in one piece of resilient synthetic resinous material. The first holding member includes at its top a male end portion detachably engaged in the female end portion of the hanging member, and at its bottom a female end portion. The first holding member further includes at least one lateral receptacle for reception of a tool bit. Similar to the first holding member, the second holding member includes at its top a male end portion detachably engaged in the female end portion of the first holding member, and at its bottom a female end portion substantially identical in construction to the female end portion of the first holding member. And, the second holding member further includes at least one lateral receptacle for reception of another tool bit. Thus, two or more of the holding members may be serially connected with a desire length to carry the required tool bits only.

Preferred embodiments of the invention may have the following additional characteristics, either alone or in combination:

A third holding member may be employed in the tool bit hanger to be attached to the second holding member to increase the length of the hanger. Similarly, the third holding member is formed in one piece of resilient synthetic resinous material, and includes at its top a male end portion detachably engaged in the female end portion of the second holding member, and at its bottom a female end portion substantially identical in construction to the female end portion of the second holding member. In particular, the third holding member may further includes at least one lateral receptacle for reception of another tool bit and a pair of clamping pawls for gripping a hex bit adaptor. Furthermore, a stopper may be employed to block a central bore of the female end portion of the associated holding member.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a tool bit set with a hanger and tool bits carried on the hanger in accordance with the preferred embodiment of the present invention;

FIG. 2 is another perspective view, from another angle, of the tool bit set shown in FIG. 1;

FIG. 3 is an exploded perspective view of the tool bit set shown in FIG. 1;

FIG. 4 is a cross-sectional view of the tool bit set shown in FIG. 1 taken along the line IV-IV;

FIG. 5 is a cross-sectional view of the tool bit set shown in FIG. 1 taken along the line V-V;

FIG. 6 is a perspective view of a holding member of the tool bit hanger shown in FIG. 1;

FIG. 7 is a perspective view, from another angle, of another holding member of the tool bit hanger shown in FIG. 1;

FIG. 8 is a perspective view of another holding member of the tool bit hanger shown in FIG. 1;

FIG. 9 is another perspective view, from another angle, of the holding member of the tool bit hanger shown in FIG. 8;

FIG. 10 is an exploded perspective view of the holding member of the tool bit hanger shown in FIG. 9;

FIG. 11 is a perspective view of the tool bit set to show an rearrangement of the holding members of the hanger;

FIG. 12 illustrates the tool bit hanger hung from a belt of the user; and

FIG. 13 is a prior art.

### DETAILED DESCRIPTION OF EMBODIMENTS

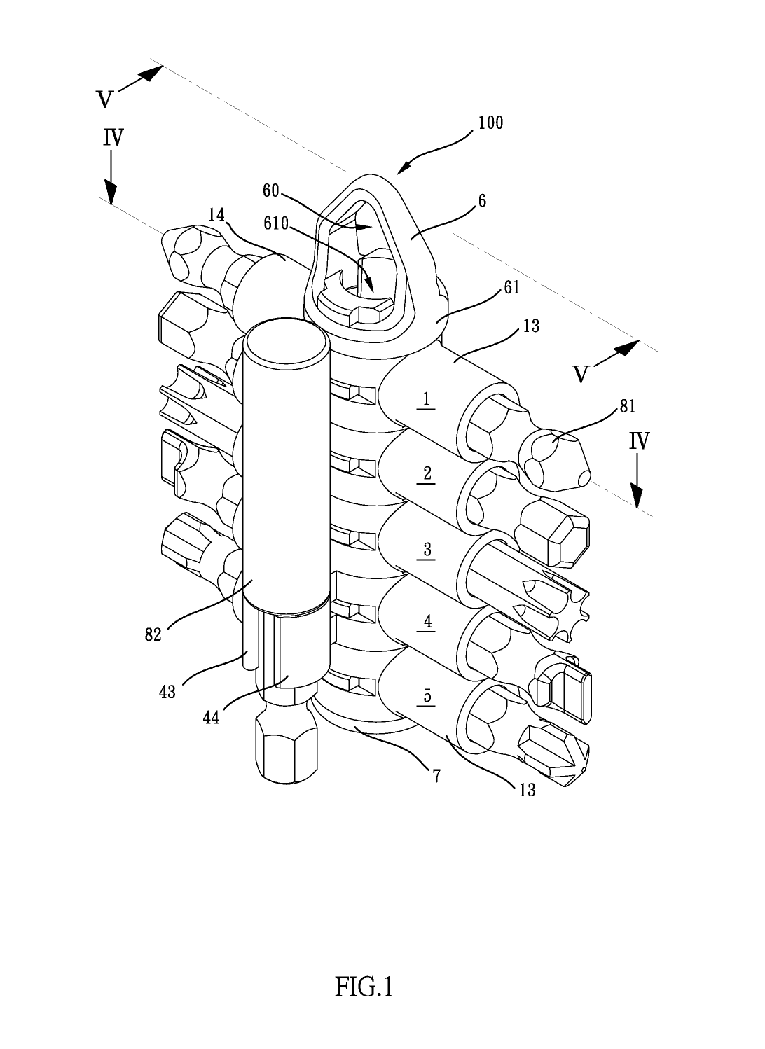

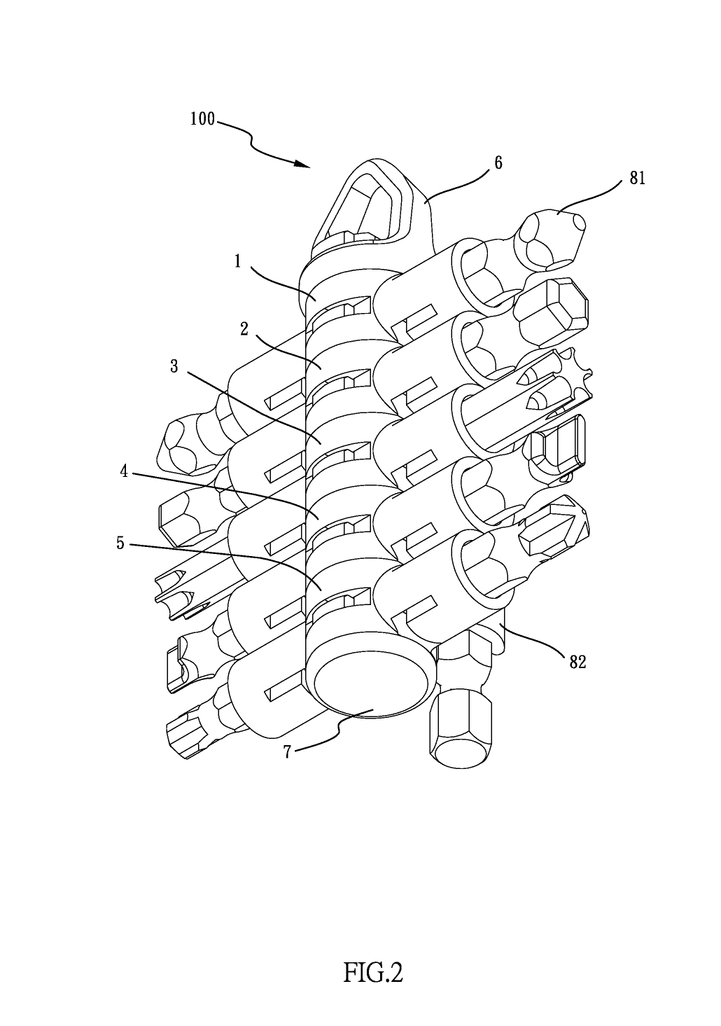

Referring to FIGS. 1 through 3, there is shown a preferred embodiment of a tool bit hanger 100 with a various of tool bits 81 carried by the hanger to form a tool bit set. The hanger 100 generally includes a series of holding members 1-5, a hanging member 6 attached to uppermost holding member 1, and a stopper 7 attached to the lowest holding member 5.

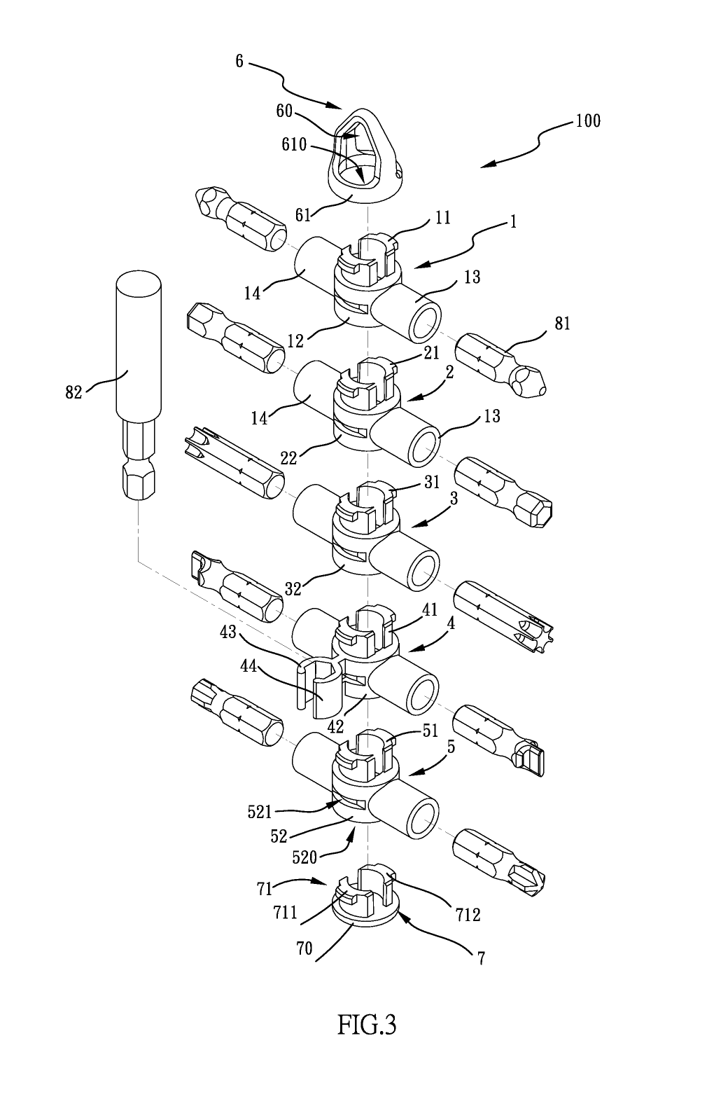

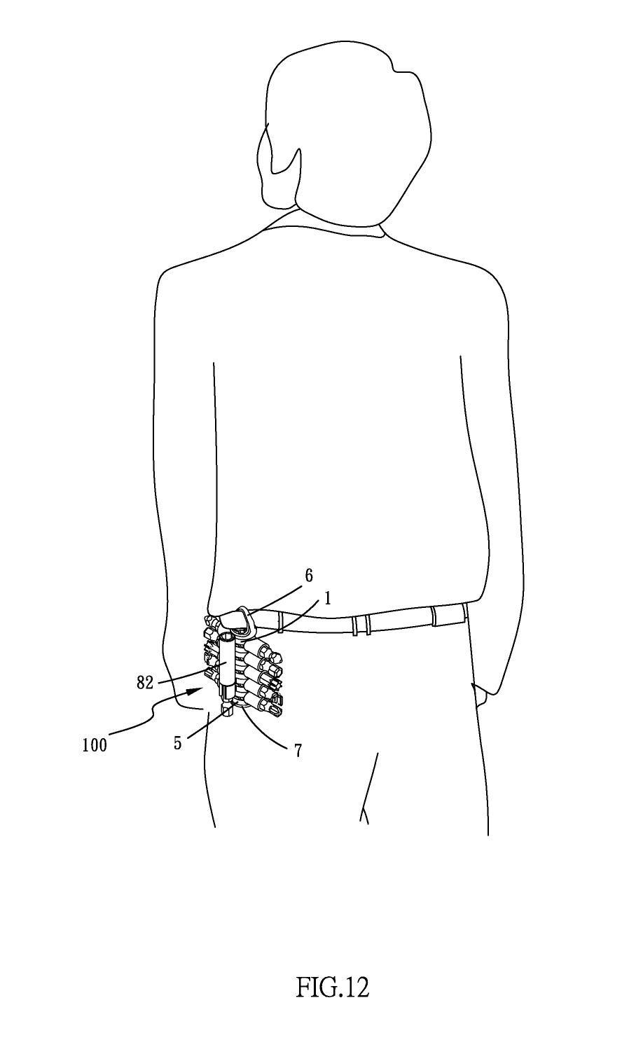

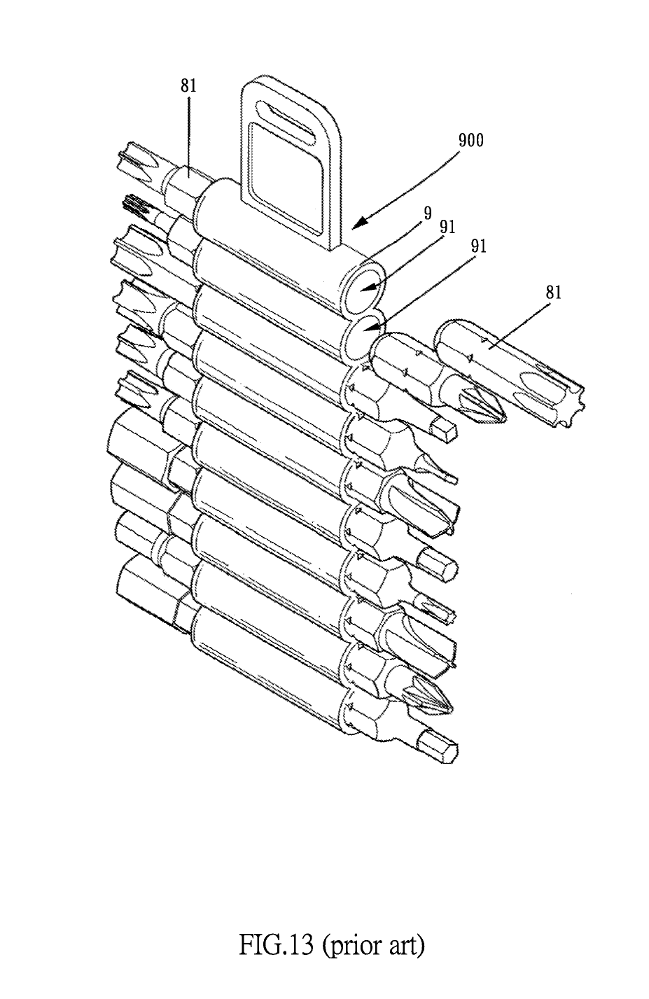

The hanging member 6 is formed in one piece of resilient synthetic resinous material and is provided at its top with a lateral hole 60 by means of which the tool bit hanger 100 is able to be hung from a belt of an user, as shown in FIG. 12. Moreover, the hanging member 6 has at its bottom a female end portion 61, as best seen in FIG. 3, which defines a central bore 610 in a bottom wall thereof and in communication with the lateral hole 60 in the top of the hanging member 6. The central bore 610 of the female end portion 61 of the hanging member 6 is provided for engagement with the first holding member 1, as will be described later.

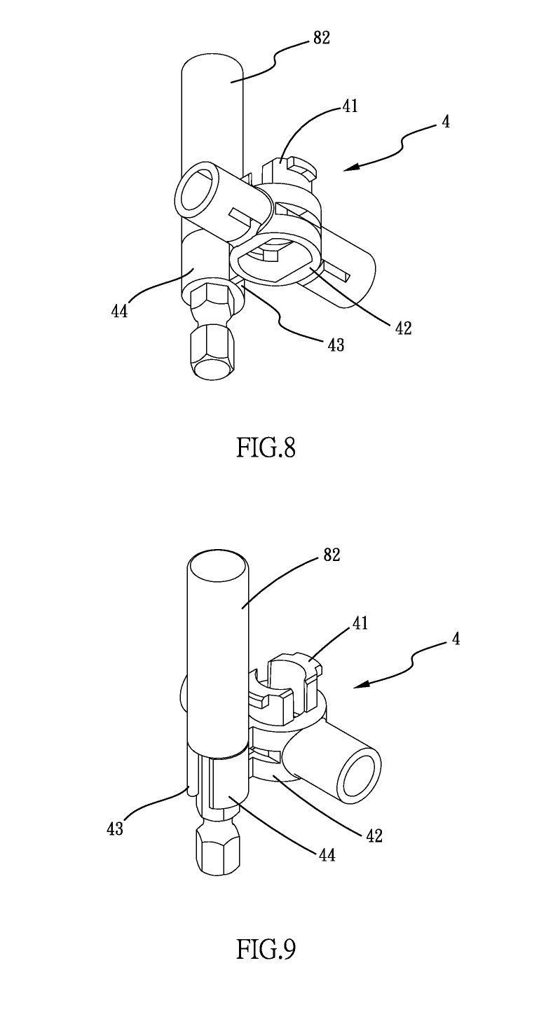

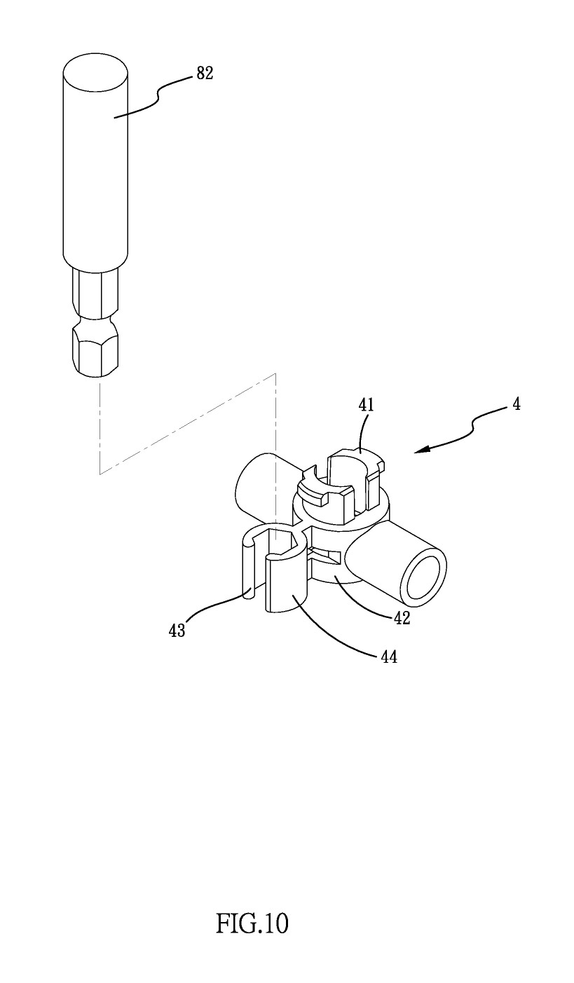

It is appreciated that all the holding members 1-5 are substantially identical in construction and each is formed in one piece of resilient synthetic resinous material, except that the fourth holding member 4 further includes a pair of clamping pawls 43, 44 for gripping an elongated hex bit adaptor 82, as shown in FIGS. 8-10, rather than the shorter tool bits 81. As shown in FIG. 1, when all the holding members 1-5 are assembled in series, the receptacles 13, 14 of the holding members 1-5 lie substantially in a same plane, and the pair of clamping pawls 43, 44 of the fourth holding member 4 is substantially vertical to that plane.

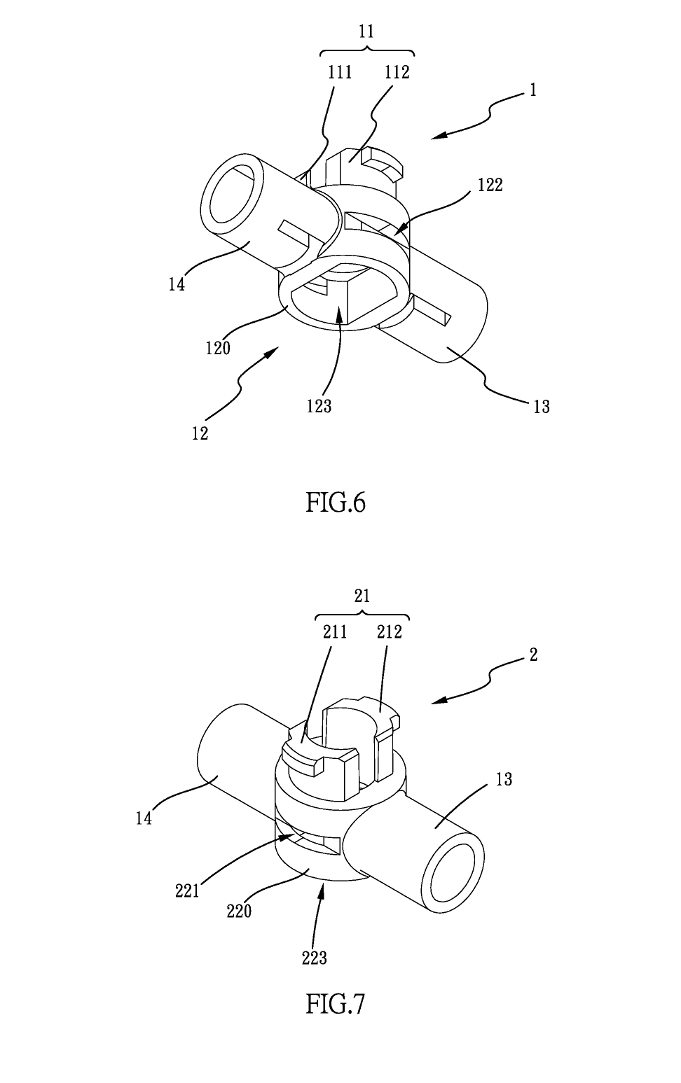

Specifically, as shown in FIG. 6, the first holding member 1 includes at its top a male end portion 11 and at its bottom a female end portion 12. The male end portion 11 of the first holding member 1 has a pair of locking tongues 111, 112. The female end portion 12 of the first holding member 1 has a hollow body 120 defining a central bore 123 in a bottom thereof and a pair of locking slots 122 in an inner wall of the central bore 123. The first holding member 1 is further formed at opposite sides thereof with a pair of lateral receptacles 13, 14 for reception of tool bits 81. The lateral receptacles 13, 14 of the first holding member 1 respectively extend from opposite sides of the hollow body 120 of the female end portion 12 of the first holding member 1.

Referring back to FIGS. 1-3, insertion of the male end portion 11 of the first holding member 1 into the central bore 610 of the female end portion 61 of the hanging member 6 causes the locking tongues 111, 112 of the male end portion 11 of the first holding member 1 to be laterally snapped in the lateral hole 60 of the hanging member 6. In this manner, the hanging member 6 and the first holding member 1 are locked together. That is, the male end portion 11 of the first holding member 1 is detachably engaged in the female end portion 61 of the hanging member 6.

Similarly, as shown in FIG. 7, the second holding member 2 includes at its top a male end portion 21 and at its bottom a female end portion 22. The male end portion 21 of the second holding member 2 has a pair of locking tongues 211, 212. The female end portion 22 of the second holding member 2 has a hollow body 220 defining a central bore 223 in a bottom thereof and a pair of locking slots 221 in an inner wall of the central bore 223. The second holding member 2 is further formed at opposite sides thereof with a pair of lateral receptacles 13, 14 for reception of tool bits 81.

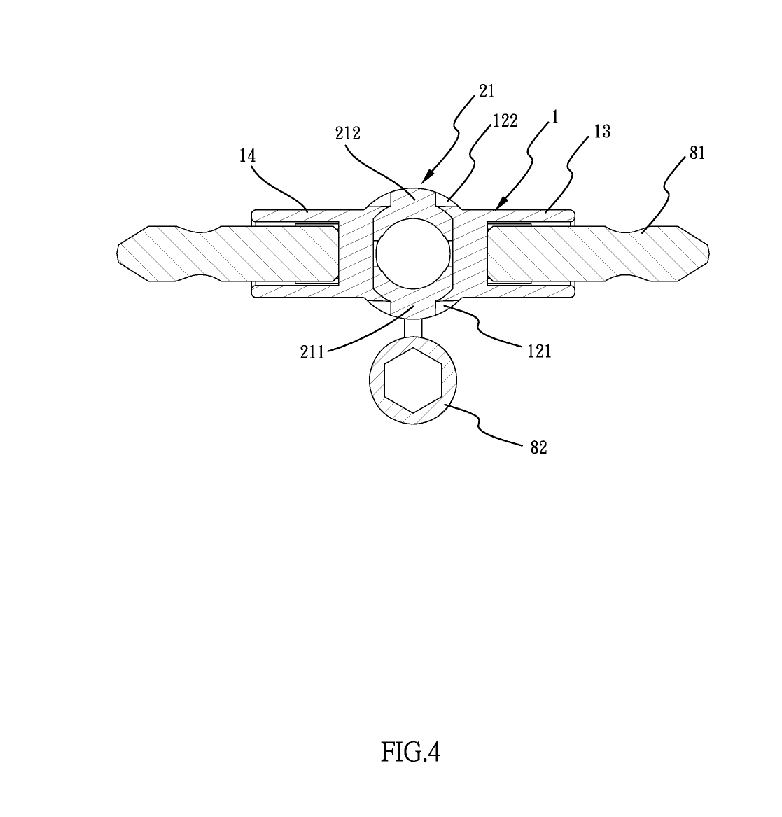

With reference to FIGS. 6 and 7, insertion of the male end portion 21 of the second holding member 2 into the central hole 123 of the female end portion 12 of the first holding member 1 causes the locking tongues 211, 212 of the male end portion 21 of the second holding member 2 to be laterally snapped in the locking slots 122 of the female end portion 12 of the first holding member 1, as depicted in FIG. 4. Thus, the first and second holding members 1, 2 are locked together.

Referring to FIG. 3, the stopper 7 includes a base 70 and a male end portion 71 on the base 70. The male end portion 71 of the stopper 7 has a pair of locking tongues 711, 712. Similarly, insertion of the male end portion 71 of the stopper 7 into the central hole 520 of the female end portion 52 of the fifth holding member 5 causes the locking tongues 711, 712 of the male end portion 71 of the stopper 7 to be laterally snapped in the locking slots 521 of the female end portion 52 of the fifth holding member 5, thereby locking the fifth holding member 5 and the stopper 7 together.

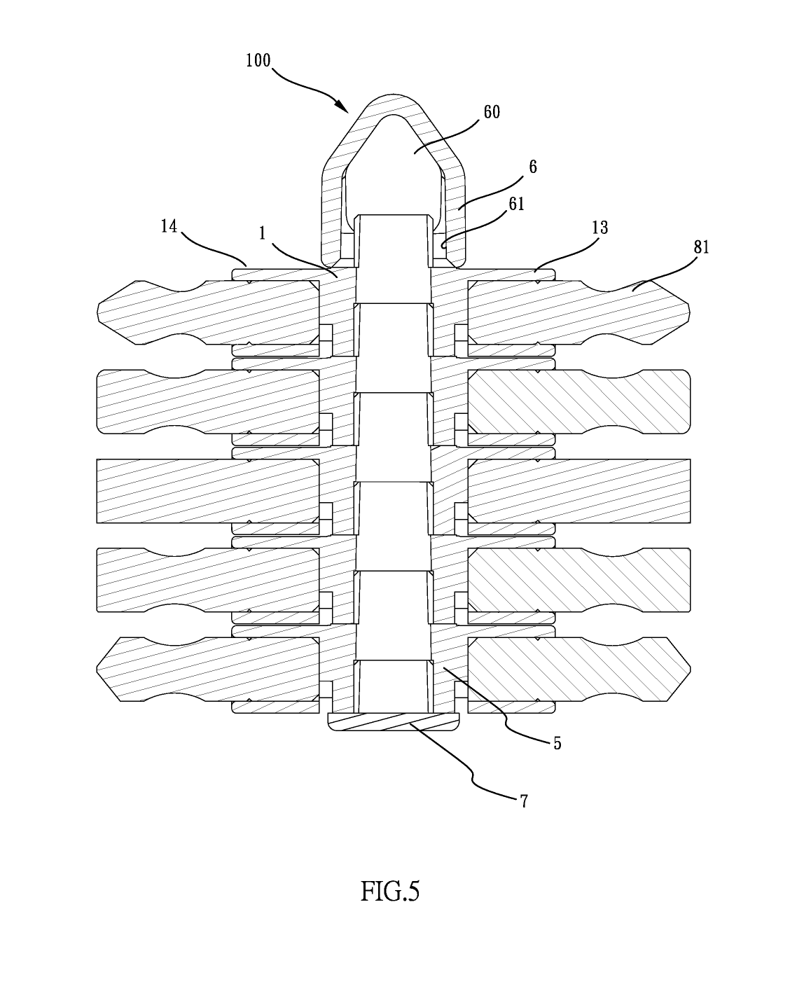

As shown in FIG. 5, the first holding member 1 can be detachably engaged in the female end portion 61 of the hanging member 6. The male end portion 21 of the second holding member 2 can be detachably engaged in the female end portion 12 of the first holding member 1. The male end portion 31 of the third holding member 3 can be detachably engaged in the female end portion 22 of the second holding member 1. The male end portion 41 of the fourth holding member 4 can be detachably engaged in the female end portion 32 of the third holding member 3. The male end portion 51 of the fifth holding member 5 can be detachably engaged in the female end portion 42 of the fourth holding member 4. And, the stopper 7 can be detachably engaged in the female end portion 52 of the fifth holding member 5 to block a central bore 520 of the female end portion 52 of the fifth holding member 5.

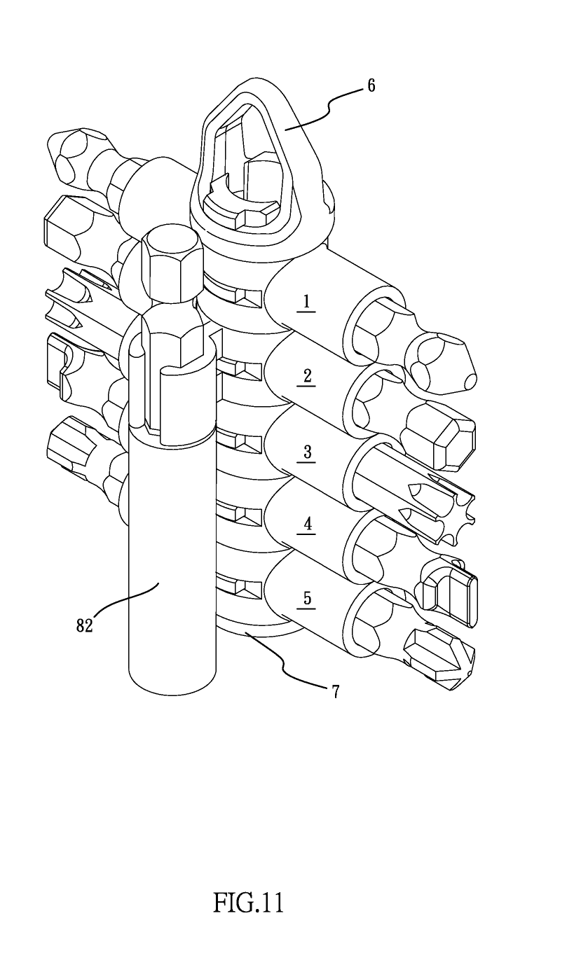

It is understood that the order of the holding members 1-5 may be changed as desired. As shown in FIG. 11, the holding members 1-5 are rearranged with the fourth holding member 4 in the place of the second holding member 2, and with the hex bit adaptor 82 turned upside down and carried by the fourth holding member 4. Alternatively, in other case where fewer tool bits 81 are required, one or more holding member along with the tool bits carried thereon may even be completely detached from the hanger for easy carrying.

It is to be understood that the disclosed embodiments are illustrative in nature and the invention is not to be limited to any one or more embodiments except as set forth in the following claims.

What is claimed is:

1. A tool bit hanger comprising:
a first holding member formed in one piece of resilient synthetic resinous material, and including a male end portion at a top thereof and a female end portion at a bottom thereof and at least one lateral receptacle for reception of a tool bit;
a second holding member formed in one piece of resilient synthetic resinous material and including at its top a male end portion to be detachably engaged in the female end portion of the first holding member, and at its bottom a female end portion substantially identical in construction to the female end portion of the first holding member, and the second holding member further including at least one lateral receptacle for reception of another tool bit; and
a hanging member attached to the first holding member and provided with a lateral hole by means of which the tool-bit hanger is able to be hung.

2. A tool bit hanger as recited in claim 1, wherein the hanging member has a female end portion defining a central bore in a bottom wall thereof and in communication with the lateral hole of the hanging member, and the male end portion of the first holding member has at least one locking tongue; and wherein insertion of the male end portion of the first holding member into the central bore of the female end portion of the hanging member causes the locking tongue of the male end portion of the first holding member to be laterally snapped in the lateral hole of the hanging member to lock the hanging member and the first holding member together.

3. A tool bit hanger as recited in claim 1, wherein the female end portion of the first holding member has a hollow body defining a central bore in a bottom thereof and at least one locking slot in an inner wall of the central bore, and the male end portion of the second holding member has at least one locking tongue; and wherein insertion of the male end portion of the second holding member into the central hole of the female end portion of the first holding member causes the locking tongue of the male end portion of the second holding member to be laterally snapped in the locking slot of the female end portion of the first holding member to lock the first and second holding members together.

4. A tool bit hanger as recited in claim 3, wherein the lateral receptacle of the first holding member extends from one side of the hollow body of the female end portion of the first holding member.

5. A tool bit hanger as recited in claim 4, wherein the first holding member further includes a second lateral receptacle extending from the opposite side of the hollow body of the female end portion of the first holding member.

6. A tool bit hanger as recited in claim 1, further comprising a third holding member formed in one piece of resilient synthetic resinous material, wherein the third holding member includes at its top a male end portion to be detachably engaged in the female end portion of the second holding member, and at its bottom a female end portion substantially identical in construction to the female end portion of the second holding member, and the third holding member further includes at least one lateral receptacle for reception of another tool bit and a pair of clamping pawls for gripping a hex bit adaptor.

7. A tool bit hanger as recited in claim 6, wherein the first, second and third holding members are assembled in series so that the receptacles of the first, second and third holding members lie substantially in a same plane, and the pair of clamping pawls of the third holding member is substantially vertical to the plane.

8. A tool bit hanger as recited in claim 1, further comprising a stopper that includes at its top a male end portion to be detachably engaged in the female end portion of the second holding member.

9. A tool bit hanger as recited in claim 8, wherein the female end portion of the second holding member has a hollow body defining a central bore in a bottom thereof and at least one locking slot in an inner wall of the central bore, and the male end portion of the stopper has at least one locking tongue; and wherein insertion of the male end portion of the stopper into the central hole of the female end portion of the second holding member causes the locking tongue of the male end portion of the stopper to be laterally snapped in the locking slot of the female end portion of the second holding member to lock the second holding member and the stopper together.

10. A tool bit set comprising a tool bit hanger as recited in claim 1 and a plurality of tool bits carried by the tool bit hanger.
